(19) United States
(12) Patent Application Publication
(10) Pub. No.: US 2008/0059099 A1
(43) Pub. Date: Mar. 6, 2008

(54) APPARATUS AND METHOD FOR CALIBRATING DISPLACEMENT OF REFLECTIVE PARTS IN DIFFRACTIVE OPTICAL MODULATOR

(75) Inventors: Eung Ju Kim, Seoul (KR); Anatoliy Lapchuk, Suwon (KR); Seung Do An, Suwon (KR); Kwan Young Oh, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 11/846,769

(22) Filed: Aug. 29, 2007

(30) Foreign Application Priority Data
Aug. 29, 2006 (KR) 1020060082285
Aug. 30, 2006 (KR) 1020060082838

(51) Int. Cl. G06F 19/00

(52) U.S. Cl. 702/104

(57) ABSTRACT

Disclosed herein is an apparatus and method for calibrating displacement of reflective parts. The apparatus includes memory, a sampling data output unit, an optical modulator drive circuit, a light detection unit, a control unit, and a calibration value calculation unit. The calibration value calculation unit receives a measured light intensity value, and outputs a constructed element-based calibration data.

### CROSS REFERENCE TO RELATED APPLICATION

This application claims the benefit of Korean Patent Application No. 10-2006-0082285, filed Aug. 29, 2006, entitled “Callibration apparatus of the reflective part in the diffractive optical modulator and method thereof”, which is hereby incorporated by reference in its entirety into this application. This application claims the benefit of Korean Patent Application No. 10-2006-0082838, filed Aug. 30, 2006, entitled “Callibration apparatus of the displacement for the reflective part in the diffractive optical modulator”, which is hereby incorporated by reference in its entirety into this application.

### BACKGROUND OF THE INVENTION

1. Field of the Invention

The present invention relates generally to an apparatus and method for calibrating the displacement of reflective parts in a diffractive optical modulator and, more particularly, to an apparatus and method for calibrating the displacement of reflective parts in a diffractive optical modulator, in which the displacement of upper reflective parts is measured by detecting the intensity of diffracted light, and the measured displacement of the upper reflective parts is calibrated.

2. Description of the Related Art

Active research into various Flat Panel Displays (FPDs) has been conducted to develop subsequent generation display devices. Among them, popularized FPDs include Liquid Crystal Displays (LCDs) using the electro-optic characteristics of liquid crystal and Plasma Display Panels (PDPs) using gas discharge.

LCDs are disadvantageous in that the viewing angle thereof is narrow, the response speed thereof is slow, and the manufacturing process thereof is complicated because Thin Film Transistors (TFTs) and electrodes must be formed through a semiconductor manufacturing process.

In contrast, PDPs are advantageous in that the manufacturing process thereof is simple, and is therefore suitable for the implementation of a large-sized screen, but are disadvantageous in that the power consumption thereof is high, the discharge and light emission efficiency thereof is low, and the price thereof is high.

New types of display devices, which can solve the disadvantages of the above-described FPDs, have been developed. Recently, there has been proposed a display device that can display images using micro Spatial Light Modulators (SLMs) that are formed for respective pixels using Micro Electromechanical Systems (hereinafter abbreviated as “MEMSs”), which are based on an ultra-micro machining technology.

The SLMs are converters that are configured to modulate incident light into a spatial pattern corresponding to electrical or optical input. The incident light may be modulated with respect to phase, intensity, polarization or direction. Optical modulation can be achieved using several materials that have several electro-optic or magneto-optic effects, or material that modulates light through surface deformation.

FIG. 1 is a perspective view of an open hole-based diffractive optical modulator.

Referring to the drawing, the open hole-based diffractive optical modulator includes a substrate 101.

The open hole-based diffractive optical modulator further includes an insulating layer 102 that is formed on the substrate 101.

The open hole-based diffractive optical modulator further includes a lower or proximal reflective part 103 that is disposed on part of the insulating layer 102 and is configured to reflect incident light that passes through the holes 106aa to 106nb of upper or distal reflective parts 106a to 106n and the spaces between the upper reflective parts 106a to 106n.

The open hole-based diffractive optical modulator further includes a pair of side support members 104 and 104′ that allow the lower reflective part 103 to be interposed therebetween, and are disposed on the surface of the substrate 101 and spaced apart from each other.

The open hole-based diffractive optical modulator further includes a plurality of laminate support plates 105a to 105n that have side portions supported by the pair of side support members 104 and 104′, are spaced apart from the substrate 101, have central portions movable upward and downward, have holes (not shown) corresponding to the holes 106aa to 106nb formed in the upper reflective parts 106a to 106n at the central portions thereof, and constitute an array.

The open hole-based diffractive optical modulator further includes the upper reflective parts 106a to 106n that are respectively formed at the central portions of the laminate support plates 105a to 105n, have the holes 106aa to 106nb at the centers thereof, so that they reflect some incident light and allow the remaining incident light to pass through the holes 106aa to 106nb, and constitute an array.

The open hole-based diffractive optical modulator further includes a plurality of pairs of piezoelectric layers 110a to 110n and 110a′ to 110n′ that are formed over the laminate support plates 106a to 106n, are spaced apart from each other, are placed over the side support members 104 and 104′, and are configured to move the laminate support plates 106a to 106n upward and downward.

In the piezoelectric layers 110a to 110n and 110a′ to 110n′, when voltage is applied to the lower electrode layers 110aa to 110na and 110aa′ to 110na′, the piezoelectric material layers 110ab to 110nb and 110ab to 110nb′ and the upper electrode layers 110ac to 110nc and 110ac′ to 110nc, the central portions of the laminate support plates 105a to 105n move upward and downward due to the contraction and expansion of the piezoelectric material layers 110ab to 110nb and 110ab′ to 110nb′. Accordingly, the upper reflective parts 106a to 106n move upward and downward. For convenience of description, a unit, including each of the laminate support plates 106a to 106n, each of the upper reflective parts 106a to 106n, and each pair of the piezoelectric layers 110a to 110n and 110a′ to 110n′, is referred to as an element.

Meanwhile, when light is incident on the upper reflective parts 106a to 106n of the open hole-based diffractive optical modulator, the upper reflective parts 106a to 106n reflect part of the incident light and allow the remaining part of the incident light to pass through the holes 106aa to 106nb, and the lower reflective part 103 reflects light that has passed through the holes 106aa to 106nb of the upper reflective parts 106a to 106n.

As a result, the light reflected from the upper reflective parts 106a to 106n and the light reflected from the lower reflective part 103 forms diffracted light having several diffraction coefficients. The intensity of the diffracted light is highest when the difference in height between the upper reflective parts 106a to 106n and the lower reflective part 103 is an odd multiple of λ/4 where λ is the wavelength of the incident light, and is lowest when the difference in height between the upper reflective parts 106a to 106n and the lower reflective part 103 is an even multiple of λ/4.

In this case, one upper reflective part 106a and the corresponding reflective portion of the corresponding lower reflective part 103 can form a scanning diffracted light spot that forms one pixel of an image formed on a screen. This will be described in more detail with reference to FIG. 2. The diffractive optical modulator includes n upper reflective parts 106a to 106n that respectively correspond to the pixel “a”, pixel “b”, pixel “c”, pixel “d”, pixel “e”, . . . , and pixel “n” of an image formed on a screen. The diffractive optical modulator will be described in conjunction with one upper reflective part 106a. Light reflected from the reflective surfaces 106a1, 106a2 and 106a3 of the upper reflective part 106a, and light passed through the open holes 107a1, 107a2 and 107a3 of the upper reflective part 106a (reference numeral 107a3 designates a gap between the upper reflective part 106a and its neighboring upper reflective part 106b) and reflected from the lower reflective part 103 form diffracted light. This diffracted light forms scanning diffracted light spot that corresponds to a pixel of an image formed on a screen.

In other words, each of the upper reflective parts 106a to 106n and its corresponding reflective portion of the lower reflective part 103 form a scanning diffracted light spot corresponding to a pixel of an image formed on a screen. A plurality of scanning diffracted light spots is arranged in a straight line and forms a scanning line (in this case, it is assumed that the scanning line is composed of n scanning diffracted light spots that respectively correspond to the n pixels of the image).

FIG. 3 is a partial sectional view of the open hole-based diffractive optical modulator, which is taken along line A-A′ of FIG. 1 and shows the sections of first and second upper reflective parts 106a and 106b.

In FIG. 3, when the interval between the upper reflective parts 106a and 106b and the lower reflective part 103 formed on an insulating layer 103 is configured to be a first interval

$$\frac{n λ}{2}$$

(where λ is the wavelength of incident light and n is an integer), the intensity of light is lowest.

Furthermore, when the interval between the upper reflective parts 106a and 106b and the lower reflective part 103 formed on the insulating layer 103 is a second interval

$$\frac{λ}{4} + \frac{n λ}{2}$$

(where λ is the wavelength of incident light and n is an integer), the intensity of light is highest.

Meanwhile, as shown in the drawing, the initial position 11i of the first upper reflective part 106a and the initial position 12i of the second upper reflective part 106b are different from each other. As a result, the amounts of displacement of the upper reflective parts 106a and 106b required to obtain beams of diffracted light having the same light intensity are different from each other. The difference in the amount of displacement results in a difference in drive voltage to be applied in order to drive the first upper reflective part 106a and the second upper reflective part 106b.

That is, for instance, in order to obtain the highest intensity of light, the first upper reflective part 106a must be displaced by 11′ or L1′, and the second upper reflective part 106b must be displaced by 12′ or L2′. Since 11≠12, voltage values that must be applied to obtain displacement are different from each other.

In short, in the diffractive optical modulator, voltages applied to drive respective upper reflective parts so as to obtain specific light intensity are different from each other. The determination of voltages to be applied in consideration of voltage characteristics at the time of actuating the respective upper reflective parts of the diffractive optical modulator is called “calibration” of the diffractive optical modulator.

### SUMMARY OF THE INVENTION

Accordingly, the present invention has been made keeping in mind the above problems occurring in the prior art, and the present invention is intended to provide an apparatus and method for calibrating the displacement of reflective parts, in which the displacement of upper reflective parts is measured by detecting the intensity of diffracted light, and the measured displacement of the upper reflective parts is calibrated in a diffractive optical modulator.

The present invention provides an apparatus for calibrating the displacement of reflective parts, including memory for storing calibration value calculation sampling data; a sampling data output unit for reading the calibration value calculation sampling data from the memory and outputting the read calibration value calculation sampling data; an optical modulator drive circuit for driving a diffractive optical modulator based on the calibration value calculation sample data output from the sampling data output unit; a light detection unit for measuring the intensity of diffracted light emitted from the diffractive optical modulator, and outputting a measured light intensity value; a control unit for controlling the sampling data output unit so that it outputs the calibration value calculation sampling data; and a calibration value calculation unit for receiving the measured light intensity value from the light detection unit after the sampling data output unit outputs the calibration value calculation sampling data, constructing element-based calibration data based on the measured light intensity value, and outputting the constructed element-based calibration data.

Furthermore, the present invention provides a method of calibrating the displacement of reflective parts, including the steps of (a) a sampling data output unit reading calibration value calculation sampling data from memory for storing the calibration value calculation sampling data and then outputting the read calibration value calculation sampling data under the control of a control unit; (b) an optical modulator drive circuit driving a diffractive optical modulator based on the calibration value calculation sample data received from the sampling data output unit; (c) a light detection unit measuring the intensity of diffracted light emitted from the diffractive optical modulator, and outputting a measured light intensity value; and (d) a calibration value calculation unit receiving the measured light intensity value from the light detection unit, constructing element-based calibration data based on the measured light intensity value, and outputting the constructed element-based calibration data.

Furthermore, the present invention provides an apparatus for calibrating displacement of reflective parts in a diffractive optical modulator, the apparatus including a diffractive optical modulator for, when a test voltage is applied thereto, diffracting incident light according to the applied test voltage, and emitting a scan line in which a plurality of scanning diffracted light spots is arranged linearly; a separation means for separating the plurality of scanning diffracted light spots from the scan line in which the plurality of scanning diffracted light spots, emitted from the diffractive optical modulator, are arranged linearly; a light detector for measuring and outputting a light intensity of the scan line incident through the separation means; and a calibration unit for applying the test voltage to the diffractive optical modulator, calculating a calibration voltage by comparing the measured light intensity value, measured by the light detector, with an expected light intensity, expected to be measured by the light detector when the test voltage is applied to the diffractive optical modulator, and reflecting the calculated calibration voltage in a later actuating voltage.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of an open hole-based diffractive optical modulator;

FIG. 2 is a plan view of the open hole-based diffractive optical modulator of FIG. 1;

FIG. 3 is a partial sectional view taken along line A-A′ of FIG. 1, which shows the sections of first and second upper reflective parts;

FIG. 4 is a block diagram showing the construction of a display device using a diffractive optical modulator to which an apparatus for calibrating the displacement of reflective parts according to an embodiment of the present invention;

FIG. 5 is a block diagram showing the display electronic system of FIG. 4;

FIG. 6 is a graph showing the intensity of diffracted light versus applied voltage in the diffractive optical modulator;

FIG. 7 is a graph showing the voltage, applied to each element of the diffractive optical modulator, versus the intensity of light;

FIG. 8 is a calibration data table stored in an element-based calibration data storage unit;

FIG. 9 is a graph illustrating an element-based calibration data calculation process;

FIG. 10 is an internal block diagram showing the apparatus for calibrating the displacement of reflective parts of FIG. 4 according to an embodiment of the present invention;

FIG. 11A is a view showing a video data output synchronization signal, and

FIG. 11B is a view showing a video data output synchronization signal and a light intensity measurement synchronization signal;

FIG. 12 is a conceptual view showing calibration value calculation sampling data;

FIG. 13 is a flowchart showing a pixel matching process according to an embodiment of the present invention;

FIG. 14 is a graph showing the output intensity of light of photodiode array depending on the input of pixel matching sampling data;

FIG. 15 is a flowchart showing a process of calculating calibration values according to an embodiment of the present invention;

FIGS. 16A to 16D are graphs showing the measured intensity of light for respective pixels;

FIG. 17 is a conceptual view illustrating a process in which a calibration value calculator of FIG. 10 calculates a calibration value;

FIG. 18 is a diagram illustrating the construction of a display device using a diffractive optical modulator, to which an apparatus for calibrating the displacement of reflecting parts in the diffractive optical modulator according to another embodiment of the present invention is applied;

FIGS. 19A and 19B are diagrams showing the construction of optical systems for calibrating the displacement of reflecting parts in a diffractive optical modulator according to further embodiments of the present invention;

FIG. 20 is a front view illustrating the effective screen section and first and second blank time sections of the screens shown in FIGS. 19A and 19B;

FIG. 21A is a conceptual diagram illustrating the overlap of scanning diffracted light spots downstream of the diffractive optical modulators shown in FIGS. 19A and 19B, and FIG. 21B is a conceptual diagram illustrating the separation of scanning diffracted light spots downstream of the condensing lenses shown in FIGS. 19A and 19B;

FIG. 22 is a diagram showing the construction of an optical system for calibrating the displacement of reflecting parts in a diffractive optical modulator according to another embodiment of the present invention;

FIG. 23 is a diagram showing the construction of an electronic system for calibrating the displacement of reflecting parts in a diffractive optical modulator according to another embodiment of the present invention; and

FIGS. 24 and 25 are graphs illustrating output light intensity in the case where first set displacement between the upper reflecting parts and the lower reflecting part increases or decreases over time.

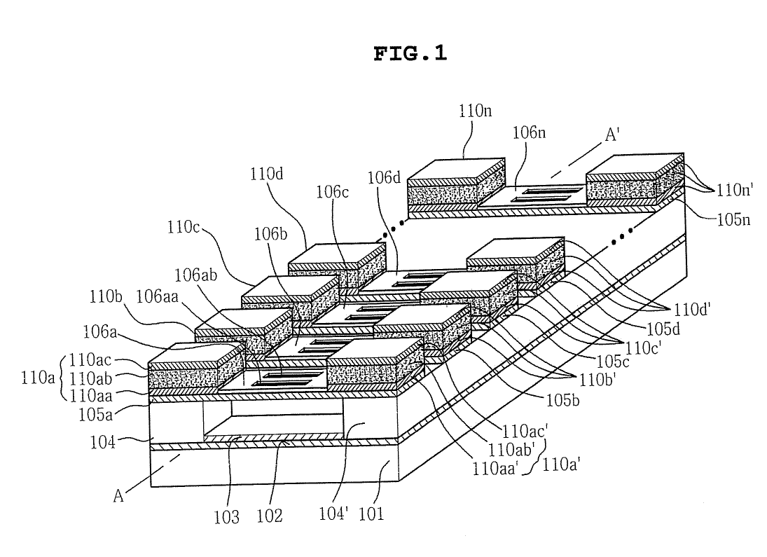

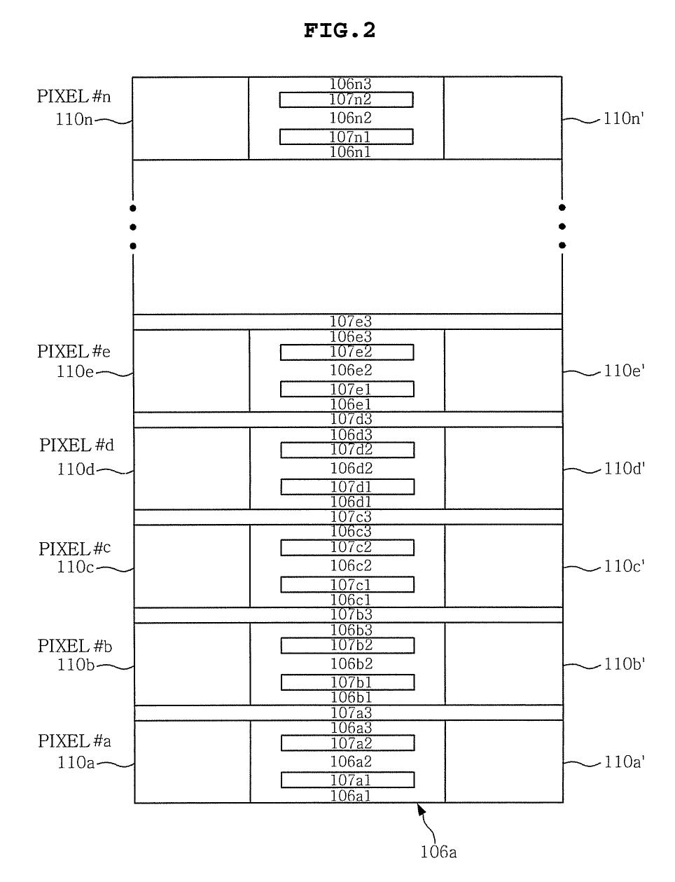

### DESCRIPTION OF THE PREFERRED EMBODIMENTS

An apparatus for calibrating the displacement of reflective parts in a diffractive optical modulator according to a preferred embodiment of the present invention will now be described in detail with reference to the accompanying drawings.

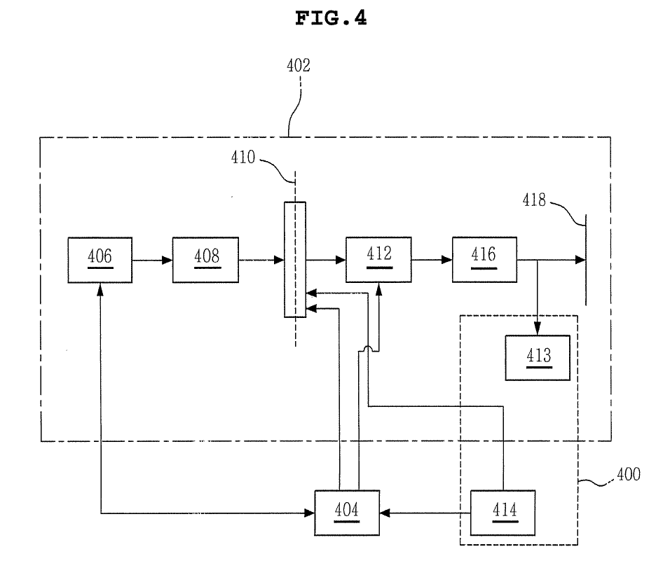

FIG. 4 is a block diagram illustrating the construction of a display device using a diffractive optical modulator to which an apparatus 400 for calibrating the displacement of reflective parts is applied according to an embodiment of the present invention.

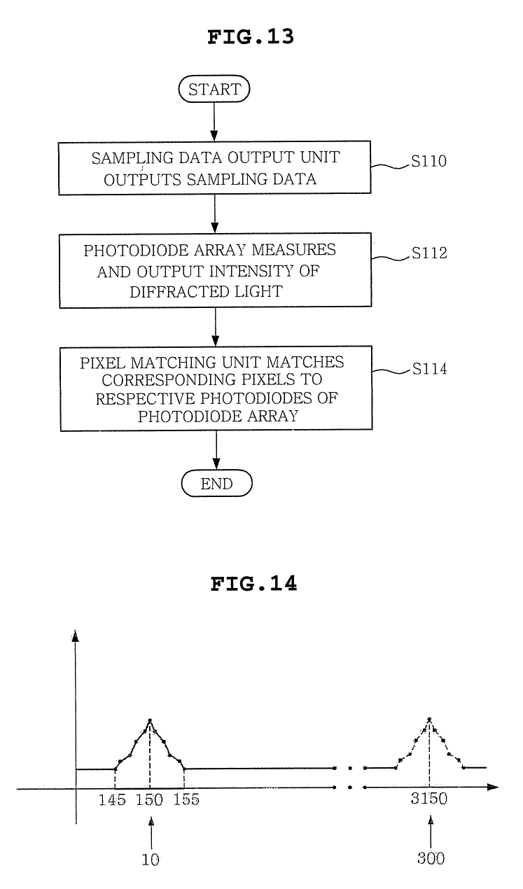

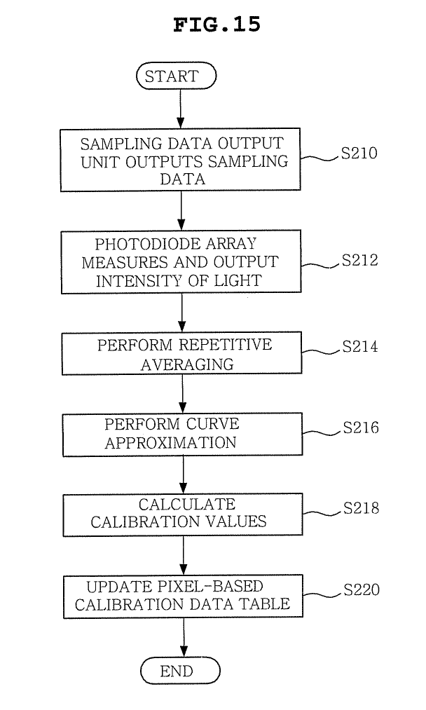

Referring to FIG. 4, the display device according to an embodiment of the present invention includes the apparatus 400 for calibrating the displacement of reflective parts, a display optical system 402, and a display electronic system 404. For convenience of description, the display optical system 402 and the display electronic system 404 will be described first, and the apparatus 400 for calibrating the displacement of reflective parts will be described later with reference to the flowcharts of FIGS. 13 and 15.

The display optical system 402 includes a light source 406 that generates light and emits the generated light. A light source formed of a semiconductor device, such as a Vertical External Cavity Surface Emitting Laser (VECSEL), a Vertical Cavity Surface Emitting Laser (VCSEL), a Light Emitting Diode (LED), a Laser Diode (LD) or a Super Luminescent Diode (SLED), may be used as the light source 406.

The light source 406 emits laser light. The laser light has a circular section, and the intensity profile of the laser light has a Gaussian distribution. For example, the light source 406 (in reality, it includes an R light source, a G light source and a B light source) can be configured to sequentially emit R light, G light and B light.

The display optical system 402 further includes an illumination optical unit 408 that radiates light, emitted from the light source 406, onto the diffractive optical modulator 410 in the form of linear parallel light.

The illumination optical unit 408 converts the laser light, emitted from the light source 406, into linear light having a long length and a narrow width, converts the linear light into parallel light, and causes the parallel light to enter a diffractive optical modulator 410.

The illumination optical unit 408 may include, for example, a convex lens (not shown), or a combination of a convex lens (not shown) and a collimating lens (not shown).

The display optical system 402 further includes the diffractive optical modulator 410 that generates diffracted light having a plurality of diffraction orders, by diffracting the linear light incident from the illumination optical unit 408.

In this case, the diffracted light emitted by the diffractive optical modulator 410 may include beams of diffracted light respectively having several diffraction orders, such as 0th-order diffracted light, ±1st-order diffracted light, ±2nd-order diffracted light and ±3rd-order diffracted light.

The diffracted light emitted by the diffractive optical modulator 410 is linear diffracted light having a long length and a narrow width.

In regard to the diffracted light emitted by the diffractive optical modulator 410, diffracted light, which is formed by one upper reflective part and the corresponding portion of the lower reflective part (both of which are referred to as “one element”), may form diffracted light corresponding to one pixel of an image formed on a screen 418, or diffracted light, which is formed by two or more upper reflective parts and the corresponding portions of the lower reflective parts (which are referred to as “a plurality of elements”), may form diffracted light corresponding to one pixel of an image formed on the screen 418.

The display optical system 402 further includes a projection unit 412 that directs the diffracted light having a plurality of diffraction orders, emitted from the diffractive optical modulator 410, toward a light intensity measurement unit 413 and/or the screen 418. In this case, the light intensity measurement unit 413 may be disposed immediately in front of the screen 418, may be disposed on one of both sides of the screen 418, or may be separate from the screen 418. For convenience of description, it is assumed that the light intensity measurement unit 413 is disposed in front of the screen 418.

The display optical system 402 further includes a filter optical unit 416 that is disposed between the projection unit 412 and the screen 418 and passes only diffracted light having a desired diffraction order, which belongs to the diffracted light having several diffraction orders that is projected by the projection unit 412, therethrough. For example, a slit may be used as the filter optical unit 416.

The display electronic system 404 is connected to the light source 406, the diffractive optical modulator 410, the projection unit 412, and the apparatus 400 for calibrating the displacement of reflective parts. The display electronic system 404 controls the switching of the light source 406. The display electronic system 404 also generates drive voltages to be applied to the upper and lower electrode layers of the piezoelectric material of the diffractive optical modulator 410 according to video data received from the outside, and outputs the drive voltages to the diffractive optical modulator 410. At this time, the display electronic system 404 generates drive voltages that are calibrated based on calibration values for gray levels classified for respective colors, which are generated by the apparatus 414 for calibrating the displacement of reflective parts, and outputs the generated calibrated drive voltages to the diffractive optical modulator 410. The display electronic system 404 controls the projection unit 412 so that the projection unit 416 projects the diffracted light onto the screen 418.

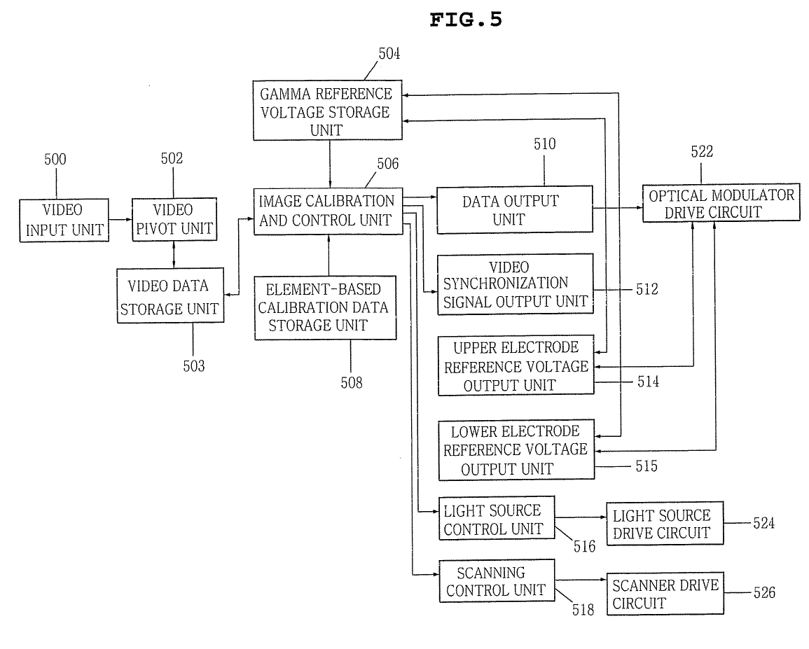

An example of the display electronic system 404 is illustrated in FIG. 5, and includes a video input unit 500, a video pivot unit 502, a video data storage unit 503, a gamma reference voltage storage unit 504, a video calibration and control unit 506, an element-based calibration data storage unit 508, a video data output unit 510, a video synchronization signal output unit 512, an upper electrode reference voltage output unit 514, a lower electrode reference voltage output unit 515, a light source control unit 516, a scanning control unit 518, an optical modulator drive circuit 522, a light source drive circuit 524, and a scanner drive circuit 526.

The video input unit 500 receives video data from the outside, and at the same time, receives a vertical synchronization signal Vsync and a horizontal synchronization signal Hsync.

The video pivot unit 502 performs a data transposition of converting laterally arranged video data into vertically arranged data, thereby converting laterally input video data into vertically arranged video data and outputting the data. The reason why data transposition is required in the video pivot unit 502 is that scan lines emitted from the diffractive optical modulator 410 are laterally scanned and displayed because scanning diffracted light spots corresponding to a plurality of pixels (for example, 480 pixels when input video data is 480*640) are vertically arranged.

During scanning, the video calibration and control unit 506 sequentially reads the video data, which is transposed by the video pivot unit 502 and stored in the video data storage unit 503, from the first column to the last column, and outputs the read video data.

When the video data is input from the video pivot unit 502, the video calibration and control unit 506 performs calibration based on an element-based calibration data table stored in the element-based calibration data storage unit 508, and outputs calibrated video data to the video data output unit 510.

In this case, the term “upper electrode (gamma) reference voltage” and “lower electrode (gamma) reference voltage” stored in the gamma reference voltage storage unit 504 refer to an upper electrode reference voltage and a lower electrode reference voltage that are considered when the optical modulator drive circuit 522 of the diffractive optical modulator 410 outputs voltages based on the gray levels of video data for respective elements.

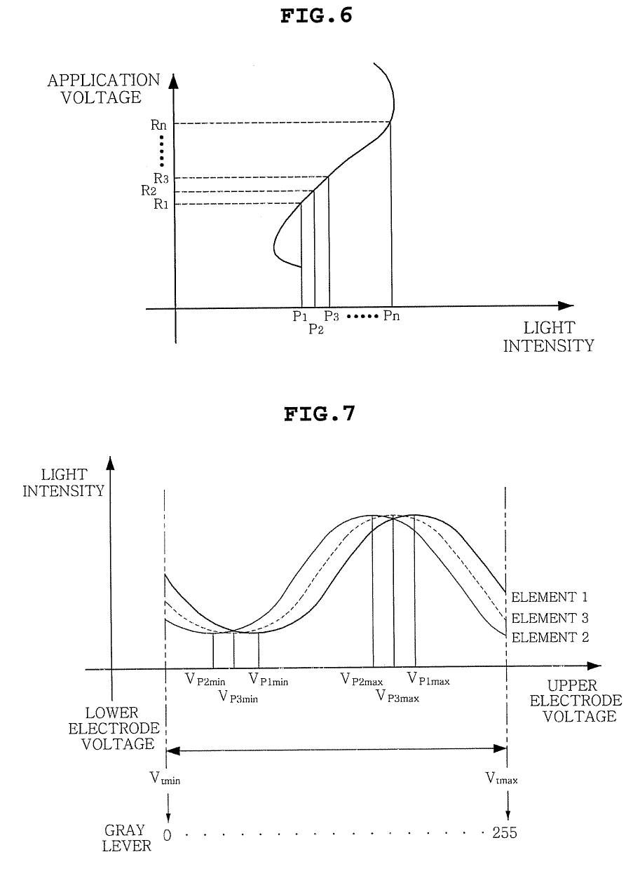

The reason why the upper electrode reference voltage and the low electrode reference voltage need to be stored in the gamma reference voltage storage unit 504 and to be considered by the optical modulator drive circuit 522 of the diffractive optical modulator 410 when the optical modulator drive circuit 522 outputs an applied voltage based on the gray level is that the intensity of diffracted light emitted from the diffractive optical modulator 410 has a gamma characteristic in which the intensity of diffracted light is not changed linearly according to the voltage level of the applied voltage but is changed nonlinearly, as illustrated in FIG. 6. That is, referring to the light intensity history curve of FIG. 6, the intensity of light to be obtained is linearly changed, that is, light intensities P1, P2, . . . , PN have a uniform interval, whereas applied voltages R1, R2, . . . , Rn do not have a uniform interval, but exhibit non-linearity. Therefore, the upper electrode reference voltage and the lower electrode reference voltage need to be stored in the gamma reference voltage storage unit 504 and to be considered by the optical modulator drive circuit 522 of the diffractive optical modulator 410 when the optical modulator drive circuit 522 outputs an applied voltage based on a gray level.

The upper electrode reference voltage and the lower electrode reference voltage stored in the gamma reference voltage storage unit 504 are determined for respective optical sources. For example, R upper electrode reference voltages R1 to Rn are determined for the R light source, G upper electrode reference voltages G1 to G are determined for the G light source, and B upper electrode reference voltages B1 to Bn are determined for the B light source.

When a gray level is input as the video data from the video data output unit 510, the optical modulator drive circuit 522 requests the upper electrode reference voltage output unit 514 to output an upper electrode reference voltage corresponding to the corresponding gray level in order to obtain an upper electrode reference voltage that matches the gray level. The upper electrode reference voltage output unit 514 reads the upper electrode reference voltage that is stored in the gamma reference voltage storage unit 504 and is configured to correspond to the corresponding gray level, and outputs the read upper electrode reference voltage to the optical modulator drive circuit 522. At the same time, the optical modulator drive circuit 522 requests the lower electrode reference voltage output unit 515 to provide a lower electrode reference voltage thereto. The lower electrode reference voltage output unit 515 reads the lower electrode reference voltage that is stored in the gamma reference voltage storage unit 504, and outputs the lower electrode reference voltage.

Meanwhile, the upper electrode reference voltage and the lower electrode reference voltage are obtained by, when the diffractive optical modulator 410 is fabricated, measuring the intensity of light for respective elements using a light intensity detector (for example, a photosensor) after repeatedly driving the diffractive optical modulator 410 in a specific voltage range, and constructing a light intensity history curve for the respective elements, as illustrated in FIG. 7. Examples of light intensity history curves for three different elements, which are obtained at that time, are illustrated in FIG. 7. In the drawing, for element 1, the voltage having the lowest light intensity is Vp1min and the voltage having the highest light intensity is Vp1max, for element 2, the voltage having the lowest light intensity is Vp2min and the voltage having the highest light intensity is Vp2max, and for element 3, the voltage having the lowest light intensity is Vp3min and the voltage having the highest light intensity is Vp3max.

At this time, a tester may determine an upper electrode reference voltage range so that it can include the lowest voltage capable of detecting the lowest light intensity of all elements and the highest voltage capable of detecting the highest light intensity of all elements. For example, in FIG. 7, Vtmin and Vtmax may be determined.

When the tester inputs the selected upper electrode reference voltage to the gamma reference voltage storage unit 504 as described above, the input upper electrode reference voltage is stored in the gamma reference voltage storage unit 504.

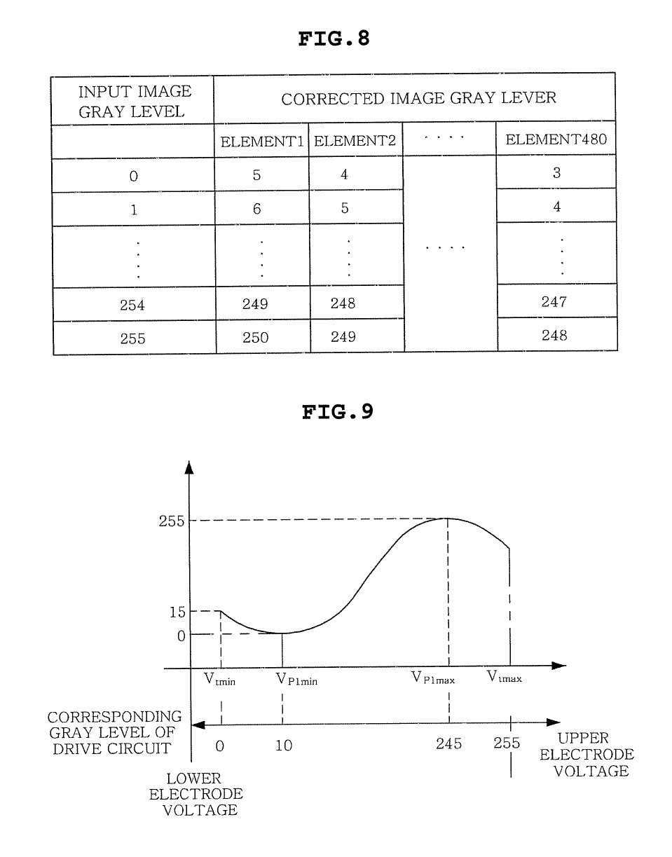

Meanwhile, the element-based calibration data stored in the element-based calibration data calculation unit 508 is considered by the video calibration and control unit 506 in order to calibrate the video data input from the video pivot unit 502 and generate calibrated output video data. The element-based calibration data may be listed in a table, as illustrated in FIG. 8.

From the calibration data table of FIG. 8, it can be seen that there are externally input video gray levels (input video data), and that calibrated video gray levels (calibrated output video data) are determined for the externally input video gray levels for respective elements.

For example, in the case of element 1, a calibrated video gray level of 5 is output when an input video gray level is 0, a calibrated video gray level of 6 is output when an input video gray level is 1, a calibrated video gray level of 249 is output when an input video gray level is 254, and a calibrated video gray level of 250 is output when an input video gray level is 255. In order to know the reason why the element-based calibration data is required, it is necessary to understand the calculation process. To understand the calculation process, it is necessary to understand the operation of the optical modulator drive circuit 522 in the display applications of the diffractive optical modulator 410.

When a gray level is input, the optical modulator drive circuit 522 requests the upper electrode reference voltage output unit 514 to output an upper electrode reference voltage for the corresponding gray level. The upper electrode reference voltage calibration unit 514 calibrates the upper electrode reference voltage stored in the gamma reference voltage storage unit 504, and outputs the calibrated upper electrode reference voltage. The optical modulator drive circuit 522 receives the calibrated upper electrode reference voltage from the upper electrode reference voltage calibration unit 514, and outputs a drive voltage corresponding to the calibrated upper electrode reference voltage. For example, assuming that the upper electrode reference voltages are R1 to Rn for the R light source, the optical modulator drive circuit 522 outputs drive voltage R1 when gray level 0 is input, drive voltage Rn when a gray level of 255 is input, and a preset drive voltage when a gray level between 0 and 255 is input. Meanwhile, as seen from FIG. 7, the upper electrode reference voltages are not set to the lowest voltage and the highest voltage for each element, but are set such that they include both the lowest voltage and the highest voltage. Accordingly, it is necessary to calculate the element-based calibration data in reverse. This is described only for element 1 below with reference to FIG. 9, which illustrates a light intensity history curve. When 0 is applied to the optical modulator drive circuit 522 without being calibrated in the case where an externally input gray level is, for example, 0, an output voltage is R1 and, at this time, the intensity of light actually output by element 1 is 15. Accordingly, in order to solve such mismatch, a gray level of 10 corresponding to Vp1min, at which element 1 actually emits an intensity of light of 0, can be output to the optical modulator drive circuit 522.

In conclusion, the element-based calibration data storage unit 508 stores calibrated video gray levels that are listed in the table as illustrated in FIG. 8, and can calibrate input video gray levels input from the outside through the above-described method.

Meanwhile, the video calibration and control unit 506 outputs the vertical synchronizing signal and the horizontal synchronizing signal, received from the video pivot unit 502, to the video synchronizing signal output unit 515.

The video calibration and control unit 506 outputs a light source switching control signal to the light source control unit 516, thus the light source control unit 516 performs control so that the light source drive circuit 524 switches the light sources, and outputs a scanning control signal to the scanning control unit 518, thus the scanning control unit 518 drives the scanner drive circuit 526.

The optical modulator drive circuit 522 receives video data (gray level) from the video data output unit 510, and requests the upper electrode reference voltage output unit 514 to output an upper electrode reference voltage. The optical modulator drive circuit 522 receives the upper electrode reference voltage from the upper electrode reference voltage output unit 514, and outputs a drive voltage corresponding to the upper electrode reference voltage to the diffractive optical modulator 410.

Meanwhile, the apparatus 400 for calibrating the displacement of reflective parts includes the light detector 413 and the reflective part displacement calibration unit 414. The apparatus 400 for calibrating the displacement of reflective parts measures the displacement of the upper reflective parts of the diffractive optical modulator 410, and adjusts calibrated video gray levels stored in the element-based calibration data storage unit 508 of the display electronic system 404.

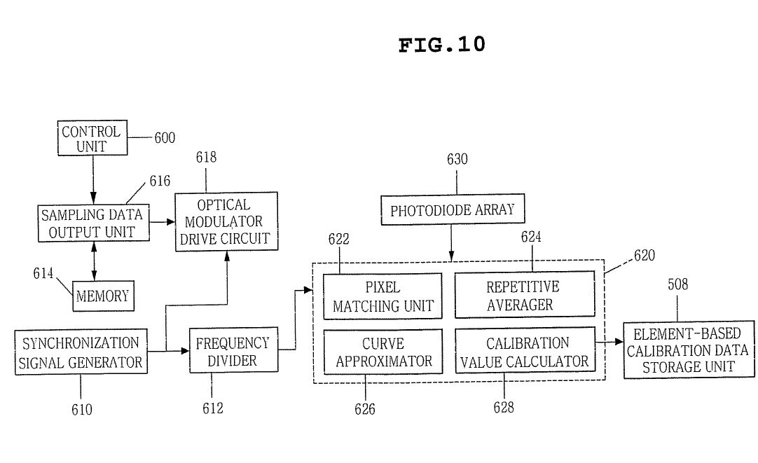

An example of the apparatus 400 for calibrating the displacement of reflective parts is illustrated in FIG. 10. The reflective part displacement calibration unit 414 includes a control unit 600, a synchronization signal generator 610, a frequency divider 612, memory 614, a sampling data output unit 616, an optical modulator drive circuit 618, and a calibration value calculation unit 620. The light detection unit 413 includes a photodiode array 630. The calibration value calculation unit 620 includes a pixel matching unit 622, a repetitive averager 624, a curve approximator 626 and a calibration value calculator 628.

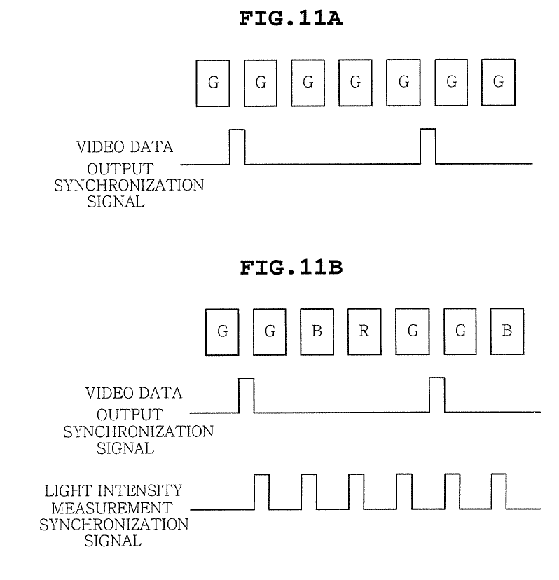

The synchronization signal generator 610, as illustrated in FIGS. 11A and 11B, generates a video data output synchronization signal and provides the generated video data output synchronization signal to the optical modulator drive circuit 618. The optical modulator drive circuit 618 is synchronized with the video data output synchronization signal generated by the synchronization signal generator 610, starts to display one frame of video data when a rising edge is detected, and repeats scanning, for example, four times.

FIG. 11A illustrates display using one color. In this case, scanning is repeated four times for one color (for example, a G color).

FIG. 11B illustrates display using three colors. In this case, when the rising edge of the video data output synchronization signal is detected, G color video data, B color video data and R color video data are sequentially displayed for, example, one frame of video data.

In the case where video is generated using several colors as described above, it is necessary to obtain element-based calibration data for respective colors. The reason for this is because wavelength varies with color. In this case, in order to obtain video for each color, the frequency divider 612 divides the frequency of the video data output synchronization signal by 4 and provides a four-divided frequency video data output synchronization signal to the photodiode array 630.

When the frequency divider 612 divides the frequency of the video data output synchronization signal by 4 and provides a four-divided frequency video data output synchronization signal to the photodiode array 630 as described above, the photodiode array 630 is reset in synchronization with the rising edge of the light intensity measurement synchronization signal, performs a new light intensity measurement operation 1, and outputs a resulting value to the calibration value calculation unit 620 after a subsequent rising edge has been detected. In other words, when the four-divided frequency light intensity measurement synchronization signal is received from the frequency divider 612, the photodiode array 630 performs a new light intensity measurement operation at every rising edge of the signal, thus performing four light intensity measurement operations, and outputs the resulting value to the calibration value calculation unit 620 after a subsequent rising edge has been detected.

The memory 614 stores pixel matching sampling data required for pixel matching (which will be described later), and calibration value calculation sampling data required for calibration value calculation.

In this case, in the pixel matching sampling data stored in the memory 614, a specific gray level is assigned to a specific pixel located in the upper half of the screen 418, and another specific pixel located in the lower half of the screen 418. The same gray level value, which greatly differs from the specific gray level assigned to the specific pixels, is uniformly assigned to the remaining pixels.

In other words, for example, in the case where video data displayed on the screen 418 is video data composed of 480*560 pixels, gray level 255 may be applied to a tenth pixel preceding a 240th pixel, the gray level 255 may be applied to a 470th pixel following the 240th pixel, and gray level 0 may be applied to the remaining pixels.

Furthermore, the calibration value calculation sampling data stored in the memory 614 may be configured to increase the gray level from a gray level 0 to gray level 255 for all pixels. That is, the gray level that increases at regular intervals may be applied in such a way that gray level 0 is applied to all pixels (in the case of a display device using a plurality of colors, the gray level must be sequentially applied to respective colors), gray level 5, spaced apart from the former gray level by a specific interval, is used, and then gray level 10 is used.

That is, the sampling data stored in the memory 614 may be implemented to output values corresponding to an increasing gray level at regular intervals in such a way that gray level 0 is output for all the pixels in a first output, gray level 5, which is obtained by adding 5 to the gray level 0, is output in a second output, and gray level 10, which is obtained by adding 5 to the gray level 5, is output in a subsequent output. In this case, in the range of low gray level values, the regular intervals may be increased, and in the range of high gray level values, the regular intervals may be decreased.

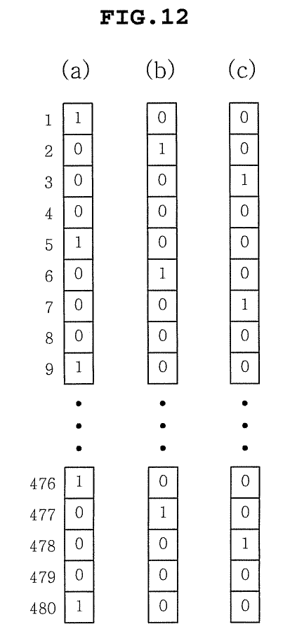

Meanwhile, the calibration value calculation sampling data stored in the memory 614 may be implemented not to provide the same value to all the pixels, but to set pause pixels so that the interference of diffracted light between the pixels can be prevented, as illustrated in FIG. 12.

In other words, referring to FIG. 12, the calibration value calculation sampling data stored in the memory 614 may be implemented to output specific sample gray levels to specific pixels at regular intervals in such a way that gray level 1 is applied to a first pixel in a first output so that the first pixel becomes an active pixel, three pixels subsequent to the first pixel are maintained at gray level 0 so that the three pixels become pause pixels, gray level 1 is applied to a fifth pixel so that the fifth pixel becomes an active pixel, three pixels subsequent to the fifth pixel are maintained at gray level 0 so that the three pixels become pause pixels, gray level 1 is applied to a tenth pixel so that the tenth pixel becomes an active pixel, and so on.

Furthermore, in a subsequent second output, not gray level 1 but gray level 0 is applied to a first pixel so that the first pixel becomes a pause pixel, gray level 1 is applied to a second pixel so that the second pixel becomes an active pixel, the three pixels subsequent to the second pixel are maintained at gray level 0 so that the three pixels become pause pixels, gray level 1 is applied to a sixth pixel so that the sixth pixel becomes an active pixel, the three pixels following the sixth pixel are maintained at gray level 0 so that the three pixels become pause pixels, gray level 1 is applied to an eleventh pixel so that the eleventh pixel becomes an active pixel, and so on.

Furthermore, the calibration value calculation sampling data may be configured to, in subsequent output, repetitively perform the above-described operation until specific sample gray levels are applied to all the pixels, and then perform the above-described operation after the sample gray level value is increased at regular intervals. Of course, the sampling data output from the sampling data output unit 616 are output for respective colors. In other words, the calibration value calculation sampling data may be implemented such that the sampling data for a G video is output when the G video is projected onto the screen 418, the sampling data for a B video is output when the B video is projected onto the screen 418, and the sampling data for an R video is output when the R video is projected onto the screen 418, as illustrated in FIG. 11B.

Meanwhile, the sampling data output unit 616 outputs the pixel matching sample data stored in the memory 614 to the optical modulator drive circuit 618, or outputs the calibration value calculation sampling data to the optical modulator drive circuit 618, under the control of the control unit 600.

The optical modulator drive circuit 618 generates drive voltages based on the pixel matching sample data or the calibration value calculation sampling data output from the sampling data output unit 616, and drives the diffractive optical modulator 410 based on the drive voltages.

The light detector 413 includes the photodiode array 630. The photodiode array 630 includes a plurality of photodiodes that are arranged in the vertical direction of the screen 418, thus forming an array. The number of photodiodes, each corresponding to one pixel of the screen 418, may be one or more. In the case where the number of photodiodes is two or more, it is necessary to determine a corresponding pixel for each photodiode. This process may be called “pixel matching.” Pixel matching may be performed by outputting the pixel matching sampling data, stored in the memory 614, to the optical modulator drive circuit 618 using the sampling data output unit 616.

The calibration value calculation unit 620 includes the pixel matching unit 622, the repetitive averager 624, the curve approximator 626, and the calibration value calculator 628. The calibration value calculation unit 620 receives a light intensity value measured by the photodiode array 630, performs pixel matching based on the light intensity value, and outputs a calibration value for calibrating the element-based calibration data stored in the element-based calibration data storage unit 508.

The control unit 600 controls the sampling data output unit 616 so that it outputs the pixel matching sampling data or the calibration value calculation sampling data.

Hereinafter, a pixel matching process and a calibration value calculation process according to an embodiment of the present invention will be described in detail with reference to FIG. 13, which shows a flowchart of the pixel matching process and FIG. 15, which shows a flowchart of the calibration value calculation process.

(1) Pixel Matching Process

The control unit 600 transmits a control signal to the sampling data output unit 616 so that the sampling data output unit 616 outputs pixel matching sampling data for pixel matching.

The sampling data output unit 616 reads sampling data for pixel matching, stored in the memory 614, from the memory 614, and outputs the read sampling data to the optical modulator drive circuit 618 at step S110.

In this case, the sampling data for pixel matching, stored in the memory 614, can be configured so that a specific pixel located in the upper half of the screen 418 has a specific gray level, a specific pixel located in the lower half of the screen 418 has the specific gray level, and the remaining pixels have the same gray level, as described above. For example, the case in which a specific gray level is assigned to a tenth pixel located in the upper half of the screen 418, and the specific gray level is assigned to a 300th pixel located in the lower half of the screen 41, may be considered.

The optical modulator drive circuit 618 generates drive voltages for driving the diffractive optical modulator 410 based on video data output values output from the sampling data output unit 616, and outputs the generated drive voltages. Thus, the photodiode array 630 measures the intensity of diffracted light emitted from the diffractive optical modulator 410, and outputs the measured intensity values of diffracted light at step S112.

The measured light intensity values, measured and output by the photodiode array 630, are illustrated in FIG. 14 as an example. Referring to FIG. 14, the ten photodiodes located before and behind the 150th photodiode of the photodiode array 630 output a measured light intensity value of 0 V or higher, and the ten photodiodes located before and behind the 3150th photodiode of the photodiode array 630 output a measured light intensity value of 0 V or higher.

Therefore, assuming that, in the above case, the sampling data output unit 616 outputs a value other than gray level 0 to a tenth pixel and outputs a value other than gray level 0 to a 300th pixel, the ten photodiodes located on either side of a 150th photodiode measure light intensity corresponding to the tenth pixel and output the measured light intensity, and the ten photodiodes located on either side of a 3150th photodiode measure light intensity corresponding to the 300th pixel and output the measured light intensity. Accordingly, the pixel matching unit 622 sets light intensity measurement photodiodes for the tenth pixel to the ten photodiodes located on either side of the 150th photodiode, and matches each pixel to ten corresponding light intensity measurement photodiodes at step S114.

In other words, specific pixels are matched to photodiodes by assigning the specific pixels to the photodiodes in such a way that photodiodes ranging from a 145th photodiode to a 154th photodiode are matched to a tenth pixel, photodiodes ranging from a 155th photodiode to a 164th photodiode are matched to an eleventh pixel, photodiodes ranging from a 165th photodiode to a 174th photodiode are matched to a twelfth pixel, and so on.

(2) Calibration Value Calculation Process

The control unit 600 transmits a control signal to the sampling data output unit 616 so that the sampling data output unit 616 outputs calibration value calculation sampling data stored in the memory 614.

Then, the sampling data output unit 616 reads the calibration value calculation sampling data from the memory 614, and outputs the read calibration value calculation sampling data to the optical modulator drive circuit 618.

The calibration value calculation sampling data stored in the memory 614 may be configured such that the gray level increases from gray level 0 to gray level 255 at regular intervals for all pixels, or may be configured to have active pixels and pause pixels, as described above.

Here, the case where the sampling data stored in the memory 614 has calibration value calculation sampling data comprised of active pixels and pause pixels will be described.

Accordingly, in a first output, the sampling data output unit 616 outputs specific gray levels to specific pixels at regular intervals in such a way that gray level 1 is applied to a first pixel, the three pixels subsequent to the first pixel are maintained at gray level 0, gray level 1 is applied to a fifth pixel, the three pixels subsequent to the fifth pixel are maintained at gray level 0, a ninth pixel is maintained at gray level 1, and so on.

In a second output, the sampling data output unit 616 outputs specific gray levels to specific pixels in such a way that gray level 1 is not applied to a first pixel, but gray level 1 is applied to a second pixel, the three pixels subsequent to the second pixel are maintained at gray level 0, gray level 1 is applied to a sixth pixel, the three pixels subsequent to the sixth pixel are maintained at gray level 0, gray level 1 is applied to a tenth pixel, and so on.

In a subsequent output, the sampling data output unit 616 repeats the above-described operation until the specific sample gray level is applied to all the pixels, and then repeats the above-described operation after the sample gray level value is increased by a regular interval or more, at step S210. At this time, the sampling data output from the sampling data output unit 616 may be output for respective colors. That is, the sampling data for G video is output when the G video is projected onto the screen 418, the sampling data for B video is output when the B video is projected onto the screen 418, and the sampling data for R video is output when the R video is projected onto the screen 418, as illustrated in FIG. 11B.

Then, the photodiode array 630 measures the intensity of light and outputs the measured intensity of light. At this time, the photodiode array 630 measures the intensity of light for a corresponding color at the time when the corresponding color of FIG. 11B is projected, and outputs the measured intensity of light at step S212.

Of course, since measured light intensity values output from the photodiode array 630 do not form a smooth curve, and thus it is difficult to handle them in a subsequent process. Therefore, the measured light intensity values approximate a smooth curve using the curve approximator 626 at step S214.

Furthermore, the control unit 600 may control the sampling data output unit 616 so that it repetitively outputs sampling data while varying the gray level from a low gray level to a high gray level (and vice versa) in order to obtain accurate data.

Then, the photodiode array 630 measures the intensity of light and outputs measured light intensity values. The repetitive averager 624 repetitively averages the measured light intensity values and outputs the result at step S216.

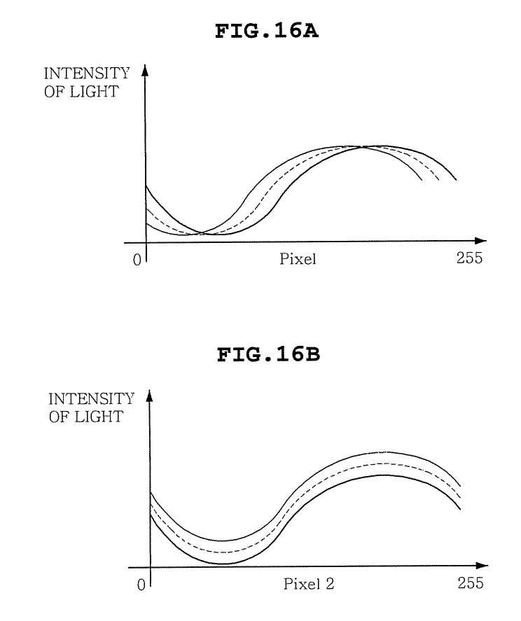

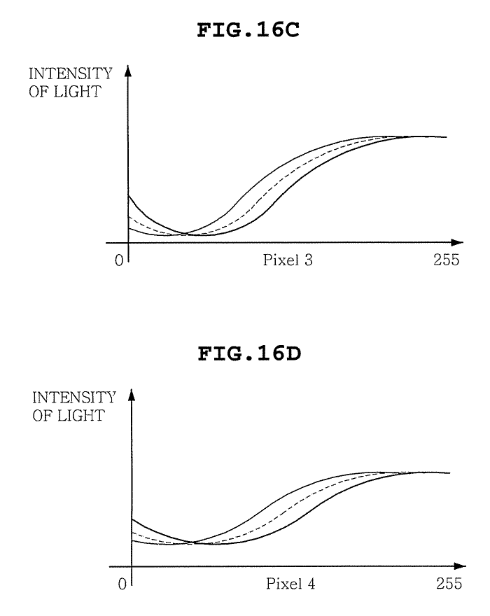

That is, as illustrated in FIGS. 16A to 16D, when the process is repeated twice, average values are calculated and output.

Meanwhile, it can be seen from the measurement values shown in FIGS. 16A to 16D that the light intensity value that is actually output when gray level 0 is applied is not a value corresponding to gray level 0.

Therefore, the calibration value calculator 628 calculates calibration values that are used to obtain output light intensity values corresponding to respective applied gray levels, for the respective applied gray levels.

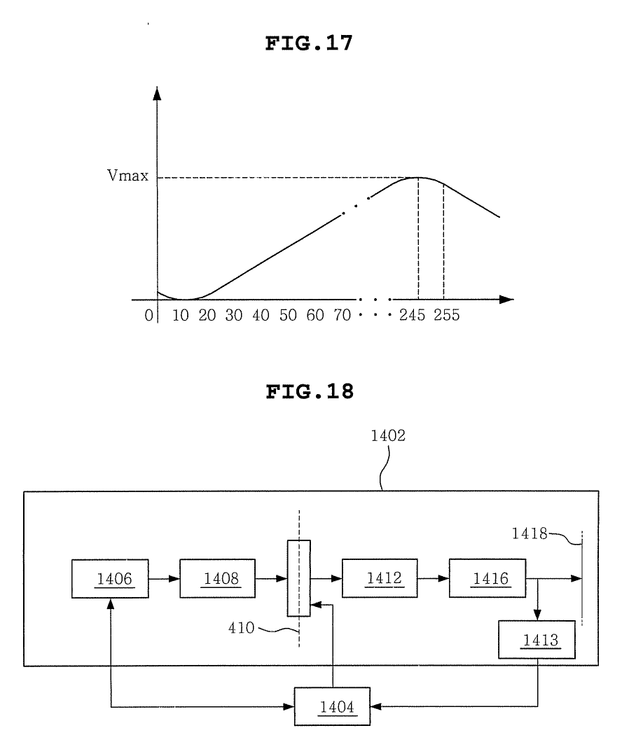

In other words, a description will be given with reference to FIG. 17 as an example. From FIG. 17, it can be seen that a light intensity value of 0 is not obtained, but that an output value greater than 0 is output, when gray level 0 is input. In this case, an output value of 0 can be obtained by designating a calibration value of 10 for gray level 0.

Therefore, the calibration value calculator 628 obtains a calibration value of 10 for gray level 0, assigns a calibrated gray level of 10 to the gray level 0 of a corresponding element stored in the element-based calibration data storage unit 508, and stores the calibrated gray level of 10 in the element-based calibration data storage unit 508.

By doing so, when input video data is gray level 0, the video data output unit 510 of the display electronic system 404 outputs gray level 10 and obtains a light intensity value of 0. Accordingly, desired video can be obtained.

The above-described principle is also applied to gray level 255. It can be seen that, when gray level 255 is input, a light intensity value of Vmax is not obtained, but an output value smaller than Vmax is obtained. In this case, if a calibration value of 245 is designated for gray level 255, an output value of Vmax can be obtained.

Therefore, the calibration value calculator 628 obtains a calibration value of 245 for gray level 255, assigns a calibrated gray level of 245 to the gray level 255 of a corresponding element stored in the pixel-based calibration data storage unit 508, and stores the calibrated gray level of 245 in the pixel-based calibration data storage unit 508.

By doing so, when the input video data is gray level 255, the video data output unit 510 of the display electronic system 404 outputs gray level 245, and obtains a light intensity value of Vmax. In this way, desired video can be obtained.

As described above, the calibration value calculator 628 calculates calibration values for respective elements corresponding to all the pixels, stores the calculated calibration values in the pixel-based calibration data storage unit 508, calculates calibration values for respective colors, and stores the calculated calibration values in the pixel-based calibration data storage unit 508.

FIG. 18 is a diagram illustrating the construction of a display device using a diffractive optical modulator, to which an apparatus for calibrating the displacement of reflecting parts in the diffractive optical modulator according to another embodiment of the present invention is applied.

Referring to FIG. 18, a display device using a diffractive optical modulator, to which an apparatus for calibrating the displacement of reflecting parts in the diffractive optical modulator according to another embodiment of the present invention is applied, includes a display optical system 1402 and a display electronic system 1404.

The display optical system 1402 includes a light source 1406 that generates and emits light. A light source formed of a semiconductor, such as a Vertical External Cavity Surface Emitting Laser (VECSEL), a Vertical Cavity Surface Emitting Laser (VCSEL), a Light Emitting Diode (LED), a Laser Diode (LD), or a Super Luminescent Diode (SLED), may be used as the light source 1406.

The light source 1406 emits laser light. The cross-section of the laser light is circular. The intensity profile of laser light has a Gaussian distribution. As an example, the light source 1406 (which actually includes an R light laser, a G light laser, and B light laser) may be configured to emit R light, G light and B light.

The display optical system 1402 has an illumination optical unit 1408 so that light emitted from the light source 1406 can be radiated onto the diffractive optical modulator 1410 in the form of linear parallel light.

The illumination optical unit 1408 forms the laser light, emitted from the light source 1406, to be linear, long, narrow light, converts the light into parallel light, and causes the parallel light to be incident on the diffractive optical modulator 1410.

The illumination optical unit 1408 is formed of, for example, a convex lens (not shown), or is formed of a convex lens (not shown) and a collimating lens (not shown).

The display optical system 1402 includes a diffractive optical modulator 1410 that produces diffracted light having a plurality of diffraction orders, the intensity of which is adjusted, by diffracting the linear light emitted from the illumination optical unit 1408.

Here, the diffracted light emitted from the diffractive optical modulator 1410 includes diffracted light having a plurality of diffraction orders, such as 0th-order diffracted light, ±1st-order diffracted light, ±2nd-order diffracted light, ±3rd-order diffracted light and the like. Odd-order diffracted light and even-order diffracted light have a phase difference of 180° therebetween.

The diffracted light emitted from the diffractive optical modulator 1410 is linear, long, narrow diffracted light.

The diffracted light emitted from the diffractive optical modulator 1410 may be configured such that diffracted light produced by a single upper reflecting part and its corresponding lower reflecting part forms a diffracted light corresponding to one pixel of an image formed on a screen 1418, or such that diffracted light produced by two or more upper reflecting parts and their corresponding lower reflecting parts form diffracted light corresponding to one pixel of an image formed on the screen 1418.

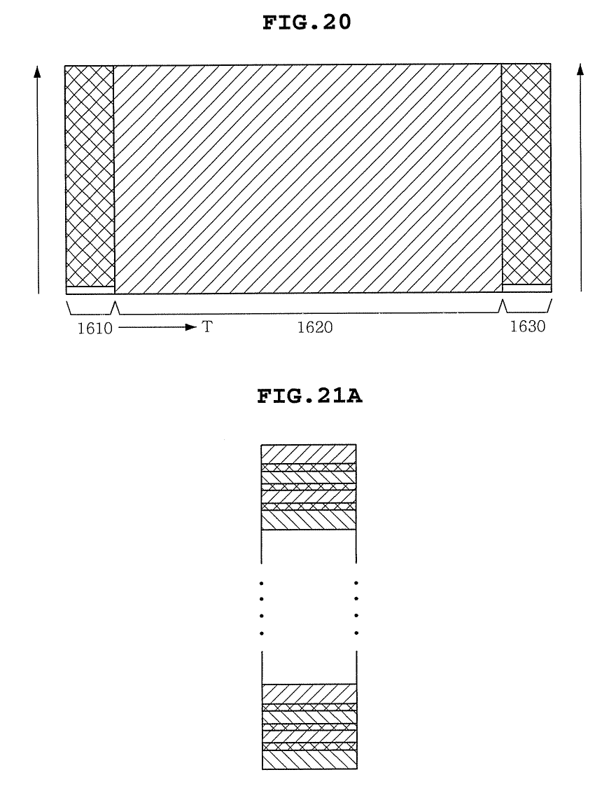

The display optical system 1402 includes a projection unit 1412 that scans the diffracted light having a plurality of diffraction orders, emitted from the diffractive optical modulator 1410, onto the screen 1418 by directing the diffracted light toward the light intensity measurement unit 1413 in a specific time period (a blank time sections 1610 and 1630 in FIG. 20) and toward the screen 1418 in the other time period, or by directing only a small part of the diffracted light toward the light intensity measurement unit 1413 and most of the diffracted light toward the screen 1418.

That is, the projection unit 1412, when diffracted light is emitted from the diffractive optical modulator 1410, directs diffracted light having a plurality of diffraction orders toward the light intensity measurement unit 1413 in specific periods (blank time periods 1610 and 1630 in FIG. 20) and toward the screen 1418 in the other time period (an effective screen section 1620 in FIG. 20), or directs a small part of the diffracted light toward the light intensity measurement unit 1413 and most of the diffracted light toward the screen 1418.

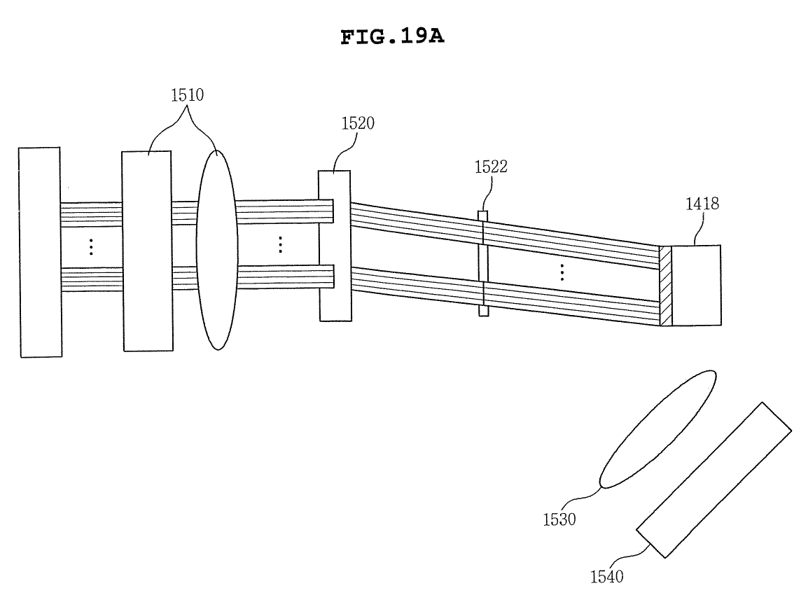

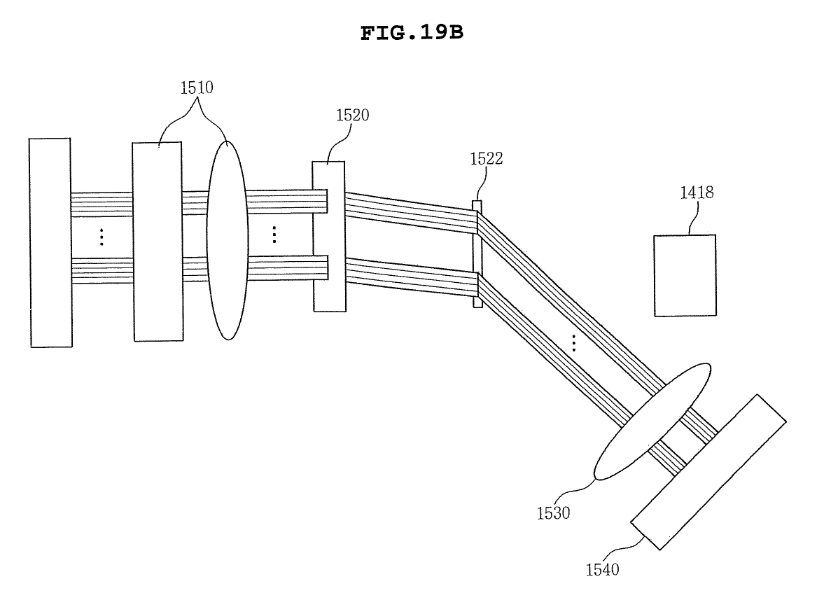

The projection unit 1412 scans diffracted light onto the screen 1418 by directing the diffracted light toward the screen 1418. Examples of such a projection unit 1412 are illustrated in FIGS. 19A and 19B. The examples each include a projection lens 1510 and a scanner 1520 for performing scanning so that diffracted light is directed toward the screen 1418.

The projection lens 1510 is formed of a combination of a plurality of convex lenses and a plurality of concave lenses, and functions to condense incident light so that diffracted light is focused on the screen 1418.

The scanner 1520 may be a galvanometer scanner or a polygon mirror scanner. The galvanometer scanner has a rectangular plate shape. A mirror is attached to one surface of the galvanometer scanner. The scanner 1520 laterally rotates around an axis within a predetermined angular range. The polygon mirror scanner has a polygonal column shape. Mirrors are attached to the side surfaces of a polygonal column. The polygon mirror scanner rotates around an axis in one direction, and projects an image onto the screen 1418 by changing the reflection angle of incident light through the rotation of the mirrors, attached to respective side surfaces, while rotating around an axis in one direction.

Meanwhile, an example of the light intensity detection unit 1413 is illustrated in FIG. 19B, and includes a reflecting mirror 1522 (a reflecting mirror may be disposed on either one of the two sides of a screen, or reflecting mirrors are disposed on the two sides of the screen) for reflecting diffracted light, reflected from the scanner 1520, to a light detector 1540 in specific periods (blank time sections 1610 and 1630 in FIG. 20), a condensing lens 1530 for condensing diffracted light passed through the reflecting mirror 1522, and a light detector 1540 for measuring the light intensity of diffracted light passed through the condensing lens 1530.

Here, the reflecting mirror 1522 is disposed downstream of the scanner 1520, must be located on the right or left side of the screen 1418, and must be disposed at a location that is capable of reflecting light incident during the blank time sections 1610 and 1630 in FIG. 20 to the light detector 1540.

Meanwhile, the condensing lens 1530 condenses linear diffracted light reflected from the reflecting mirror 1522, in which case respective scanning diffracted light spots can be clearly distinguished from each other.

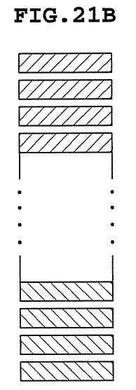

That is, before the linear diffracted light, incident through the projection lens 1510 and the scanner 1520, reaches the screen 1418, there is a plurality of regions in which scanning diffracted light spots overlap each other, as shown in FIG. 21A. Accordingly, it is impossible to accurately measure the light intensity of linear diffracted light, emitted from the diffractive optical modulator 1410, due to the regions where the scanning diffracted light spots overlap each other. Accordingly, when the condensing lens 1530 is disposed downstream of the diffractive optical modulator 1410, respective scanning diffracted light spots are condensed and distinguished from each other, as shown in FIG. 21B, with the result that the light intensity of diffracted light emitted from the diffractive optical modulator 1410 can be accurately measured. Furthermore, when the light intensity of diffracted light is measured using the condensing lens 1530, light intensity can be measured for each of the scanning diffracted light spots, therefore it is possible to calibrate the displacement for each element.

The photo sensor of the light detector 1540 can be used, and measures and outputs the light intensity of incident diffracted light.

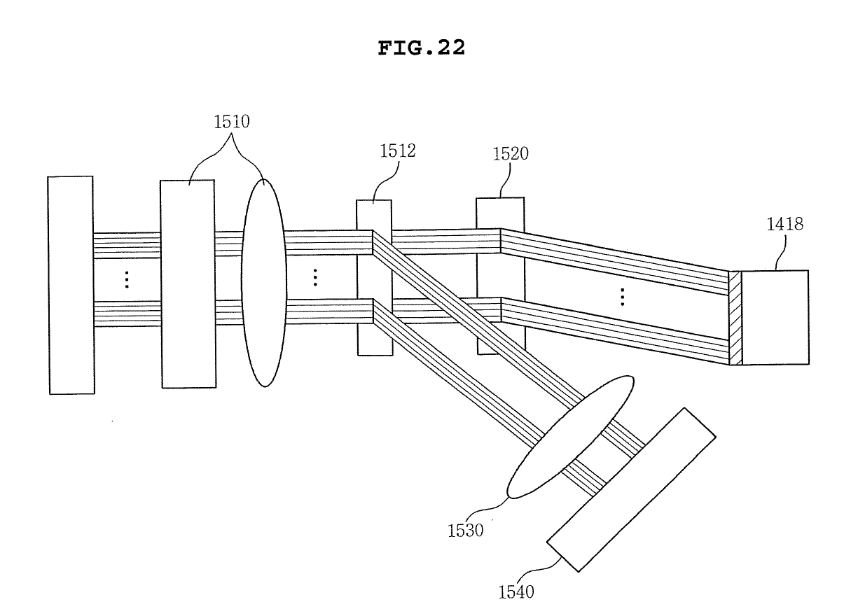

Meanwhile, another example of the light intensity detection unit 1413 is shown in FIG. 22, and includes a translucent reflecting part 1512 for reflecting part of the diffracted light, passed through the projection lens 1510, toward the light detector 1540, and passing most thereof through the scanner 1520, a condensing lens 1530 for condensing diffracted light reflected from the translucent reflecting part 1512, and a light detector 1540 for measuring the light intensity of diffracted light passed through the condensing lens 1530.

Here, the translucent reflecting part 1512 may be disposed downstream of the diffractive optical modulator 1410, preferably downstream of the projection lens 1510, and must be disposed at a location that can reflect part of the incident light toward the light detector 1540.

The condensing lens 1530 condenses linear diffracted light reflected from the translucent reflecting part 1512, therefore respective scanning diffracted light spots can be clearly distinguished from each other.

That is, before the linear diffracted light, incident through the projection lens 1510, reaches the screen 1418, there is a plurality of regions in which scanning diffracted light spots overlap each other, as shown in FIG. 21A. Accordingly, it is impossible to accurately measure the light intensity of linear diffracted light, emitted from the diffractive optical modulator 1410, due to the regions where the scanning diffracted light spots overlap each other. Accordingly, when the condensing lens 1530 is disposed downstream of the diffractive optical modulator 1410, respective scanning diffracted light spots are condensed and distinguished from each other, as shown in FIG. 21B, with the result that the light intensity of diffracted light emitted from the diffractive optical modulator 1410 can be accurately measured. Furthermore, when the light intensity of diffracted light is measured using the condensing lens 1530, light intensity can be measured for each of the scanning diffracted light spots, therefore it is possible to calibrate the displacement for each element.

Meanwhile, the display optical system 1402 includes a filter optical unit 1416, which is disposed between the projection unit 1412 and the screen 1418 and passes diffracted light having at least one desired diffraction order, selected from among diffracted light having a plurality of diffraction orders projected from the projection unit 1412, therethrough to the screen 1418. An example of the filter optical unit 1416 is a slit.

Meanwhile, the display electronic system 1404 is connected to the light source 1406, the diffractive optical modulator 1410, the projection unit 1412, and the light intensity measurement unit 1413. The display electronic system 1404 supplies power to the light source 1406. The display electronic system 1404 actuates the upper reflecting part by applying actuating voltage to the upper electrode layer and lower electrode layer of the piezoelectric element of the diffractive optical modulator 1410. At this time, the display electronic system 1404 increases or decreases actuating voltage applied to the upper electrode layer and the lower electrode layer with reference to light intensity measured by the light intensity measurement unit 1413.

That is, if the actually measured light intensity is lower than the light intensity expected to be measured when a designated actuating voltage is applied to the upper electrode layer and lower electrode layer of the piezoelectric element of the diffractive optical modulator 1410, the display electronic system 1404 determines that there is variation in the displacement of the upper reflecting part of the diffractive optical modulator 1410.

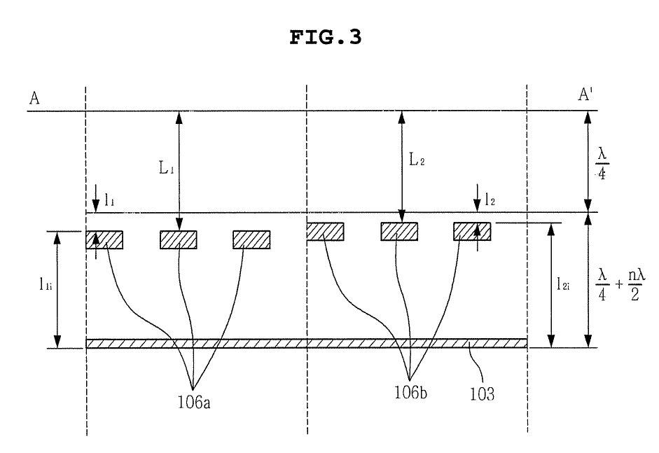

Accordingly, the display electronic system 1404 needs to move the upper reflecting part farther so as to calibrate the displacement, as shown in FIG. 3, and requires a higher actuating voltage in order to achieve this movement of the upper reflecting part. Accordingly, the display electronic system 1404 calibrates the displacement of the upper reflecting parts by performing the calibration of actuating voltage.

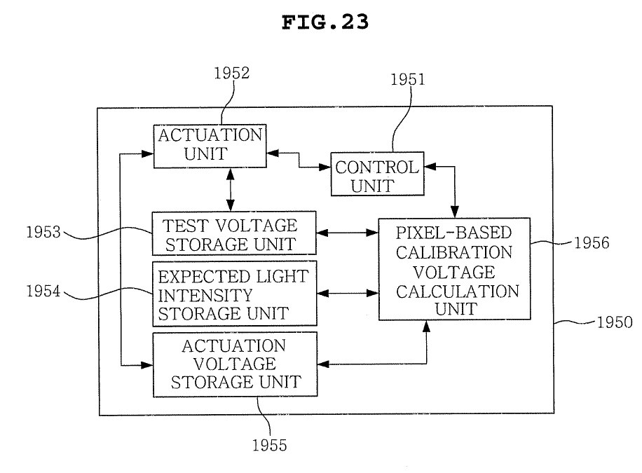

FIG. 23 is a diagram showing the construction of an electronic system 1950 for calibrating the displacement of the reflecting parts in a diffractive optical modulator according to another embodiment of the present invention.

Referring to FIG. 23, the electronic system 1950 for calibrating the displacement of reflecting parts in a diffractive optical modulator according to another embodiment of the present invention includes a control unit 1951, an actuation unit 1952, a test voltage storage unit 1953, an expected light intensity storage unit 1954, an actuation voltage storage unit 1955, and a pixel-based calibration voltage calculation unit 1956.

First, the control unit 1951 actuates the diffractive optical modulator 1410 by controlling the actuation unit 1952 using a test voltage, stored in the test voltage storage unit 1953, as actuation voltage in a specific period.

Here, the “specific time period” refers to a first blank time section 1610 or a second blank time section 1630 in FIG. 20. That is, referring to FIG. 20, a single image frame includes a main screen 1620 for displaying visual information, intended to be shown to a user, and first and second blank time sections 1610 and 1630 output before and after the main screen 1620. The control unit 1951 causes a test voltage to be applied to the diffractive optical modulator 1410 in the first or second blank time section 1610 or 1630, and, at this time, causes light intensity to be measured by the light intensity detection unit 1540 (photo diode).

Here, the first or second blank time section 1610 or 1630 may be a period in which one pixel is scanned in a lateral direction, or a period in which a plurality of pixels is scanned, and can be adjusted according to the application thereof.

Meanwhile, the actuation unit 1952, under the control of the control unit 1951, reads test voltage from the test voltage storage unit 1953 and actuates the diffractive optical modulator 1410 using the read test voltage as actuating voltage. Here, the test voltage stored in the test voltage storage unit 1953 may be an intermediate actuating voltage or one or more test voltages.

Then, the diffractive optical modulator 1410 causes the actuating voltage, applied from the actuation unit 1952, to be applied to the upper electrode layer and to contract and expand the piezoelectric element, therefore the upper reflecting part moves, and thus the diffractive optical modulator 1410 changes the intensity of incident light and emits incident light having the changed intensity.

Thereafter, the projection lens 1510 magnifies the diffracted light from the diffractive optical modulator 1410, thereby forming parallel light.

Thereafter, the light intensity measurement unit 1413 measures the intensity of the incident diffracted light and outputs the measurement result to the pixel-based calibration voltage calculation unit 1956 of the electronic system 1950 for calibrating the displacement of reflecting parts.

In an embodiment, the light intensity measurement unit 1413 measures and outputs the intensity of diffracted light corresponding to each pixel. When doing so, in the case where one upper reflecting part forms an image corresponding to one pixel of a scan line formed on the screen 1418, as described above, the intensity of diffracted light corresponding to each pixel is measured, so that the accurate displacement of each upper reflecting part can be obtained, and thus accurate calibration can be performed on displacement.

In this case, since the test voltage is set such that it is applied to the diffractive optical modulator 1410 in the first or second blank time section 1610 or 1630, as shown in FIG. 20, a configuration in which the light detector 1540 operates only in the first or second blank time sections 1610 or 1630 is favorable for the reduction in power consumption.

The light detector 1540 further includes an analog/digital converter (not shown) for converting analog signals into digital signals because the measured light intensity is composed of analog signals.

Meanwhile, the control unit 1951 controls the actuation unit 1952 so that the actuation unit 1952 actuates the diffractive optical modulator 1410 using a test voltage, and then controls the pixel-based calibration voltage calculation unit 1956 so that the pixel-based calibration voltage calculation unit 1956 calculates pixel-based calibration voltage.

Then, the pixel-based calibration voltage calculation unit 1956 calculates pixel-based calibration voltage by comparing a light intensity measurement value input from the light detector 1540 and an expected light intensity value stored in the expected light intensity storage unit 1954. That is, the expected light intensity storage unit 1954 stores light intensity values that must be measured when test voltage values stored in the test voltage storage unit 1953 are input. Of course, expected light intensity stored in the expected light intensity storage unit 1954 is the intensity of diffracted light having a specific diffraction order, which is incident on the light detector 1540.

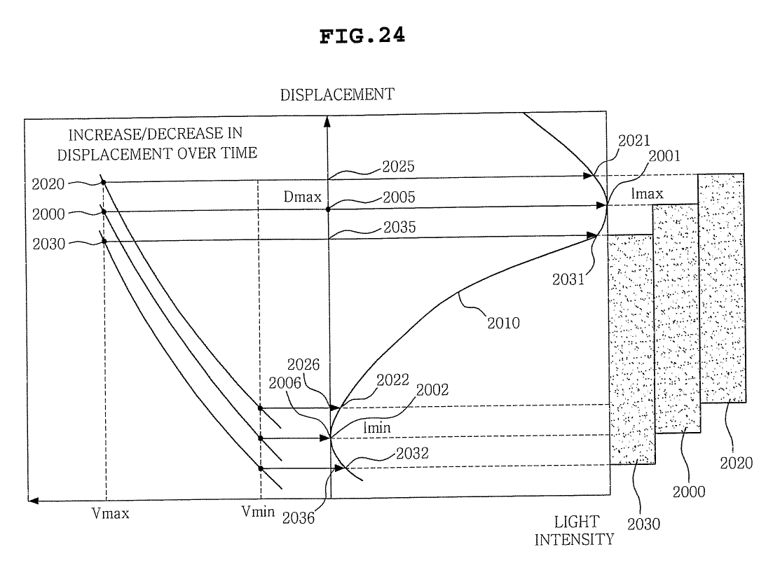

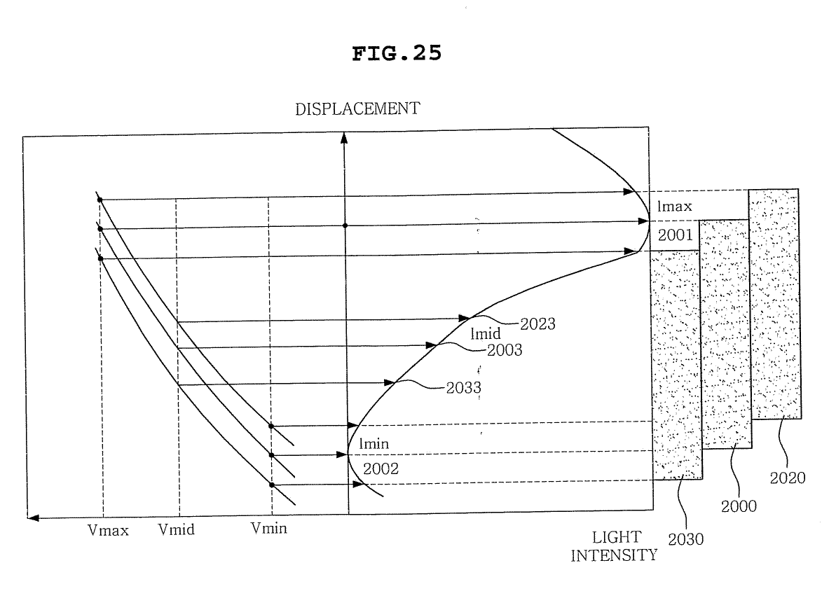

For ease of understanding, with reference to FIGS. 24 and 25, showing the case where the displacement of the upper reflecting part or lower reflecting part increases or decreases from a first set displacement, a process of calculating pixel-based calibration voltage is described below.

Referring to FIG. 24, an applied voltage versus displacement curve 1000 and a displacement versus intensity curve 2010, which are set at the time of manufacturing an upper reflecting part, are set such that, when the actuating voltage is Vmin, the displacement is Dmin 2006 and the light intensity is Imin 2002, and, when the actuating voltage is Vmax, the displacement is Dmax 2005 and the light intensity is Imax 2001.

That is, by adjusting the actuating voltage to be within the range of Vmin˜Vmax, the displacement is adjusted to a range of Dmin 2006˜Dmax 2005 and the light intensity of diffracted light falls within a range of Imin 2002˜Imax 2001, that is, the range of the minimum light intensity˜the maximum light intensity.

However, when the location of the upper reflecting part has varied from an initial location over time, as shown in FIG. 3, a displacement having an expected value and a light intensity having an expected value are not output although an actuating voltage ranging from Vmin to Vmax is used.

For example, in the case whether upper reflecting parts get closer to the lower reflecting part over time, as indicated by the first upper reflecting parts of FIG. 3, a target displacement is not obtained but a first displacement 2036˜a second displacement 2035 are obtained, even though an actuating voltage ranging from Vmin to Vmax is applied. Accordingly, the first displacement 2036 causes diffracted light having a first light intensity 2032 to be output, and the second displacement 2035 causes diffracted light having a second light intensity 2031 to be output. That is, diffracted light having the minimum light intensity and/or diffracted light having the maximum light intensity are intended to be output, but diffracted light having the first light intensity 2032 and/or the second light intensity 2031, other than the minimum light intensity 2002 and/or the maximum light intensity 2001, is output.

As another example, in the case where the upper reflecting parts get farther from the lower reflecting part, a target displacement is not obtained but a third displacement 2026˜a fourth displacement 2025 are obtained, even though an actuating voltage ranging from Vmin to Vmax is applied. Accordingly, the third displacement 2026 causes diffracted light having the third light intensity 2022 to be output, and the fourth displacement 2025 causes diffracted light having the fourth light intensity 2021 to be output. That is, diffracted light having the minimum light intensity and/or diffracted light having the maximum light intensity are intended to be output, but diffracted light having the third light intensity 2022 and/or the fourth light intensity 2021, other than the minimum light intensity 2002 and/or the maximum light intensity 2001, are output. As a result, a time-based displacement versus light intensity curve 2010 is not changed, and an actuating voltage versus displacement curve 2000 is converted into a displacement increase curve 2020 or a displacement decrease curve 2030, so that the above-described problem is overcome by calibrating the displacement.

In the case where the minimum light intensity (Imin) 2002 is focused on, the third light intensity 2022, which is light intensity when the displacement corresponds to the increased third displacement 2026, and the first light intensity 2032, which is light intensity when the displacement corresponds to the decreased first displacement 2036, are all higher than the minimum light intensity (Imin) 2002), so that it is difficult to determine whether the displacement has been increased or decreased.

In contrast, in the case where the maximum light intensity (Imax) 2001 is focused on, the fourth light intensity 2021, which is light intensity when the displacement corresponds to the increased fourth displacement 2025, and the second light intensity 2031, which is light intensity when the displacement is the decreased second displacement 2035, are all lower than the maximum light intensity (Imax) 2001, so that it is difficult to determine whether the displacement has been increased or decreased.

Accordingly, in an embodiment, as shown in FIG. 24, an intermediate displacement (Dmid) 2007 and an intermediate actuating voltage (Vmid) corresponding to an intermediate light intensity (Imid) 2003 between the minimum light intensity (Imin) and the maximum light intensity (Imax) are used for tests.

When the intermediate actuating voltage (Vmid) is used as the test voltage, a fifth displacement 2027 is obtained and a corresponding fifth light intensity 2023 is plotted, according to the displacement increase curve 2020. According to the displacement decrease curve 2030, a sixth displacement 2037 is obtained and a corresponding sixth light intensity 2033 is plotted. Compared to the intermediate light intensity (Imid) 2003, the fifth light intensity 2023 has a great value and the sixth light intensity 2033 has a less value, so that it is possible to obtain information about whether the distance between corresponding upper reflecting part and lower reflecting part, that is, a displacement, has been increased or decreased. Based on this, it is possible to determine whether to increase or decrease the displacement.

Alternatively, three or more arbitrary actuating voltages are selected from an actuating voltage range from Vmin to Vmax as test voltages, and corresponding displacements and light intensities are searched for. Three or more displacements and three or more light intensities are found to correspond to the three or more actuating voltages, and it is possible to search for a maximum point and a minimum point for a curve that is approximated to a light intensity versus actuating voltage relationship based on the found values. The reason for this is that the displacement versus light intensity curve 2010 has a shape similar to a cubic curve (refer to FIG. 25), so that it is possible to approximate to the displacement versus light intensity curve 2010 based on the three points.

As described above, when the pixel-based calibration voltage calculation unit 1956 calculates a calibration voltage, the test voltage storage unit 1953 updates a test voltage value based on the calculated calibration voltage, updates the expected light intensity value of the expected light intensity storage unit 1954, and updates the actuating voltage of the actuation voltage storage unit 1955, thereby completing calibration. Here, actuating voltages, which must be applied to obtain desired light intensities, are stored in the actuation voltage storage unit 1955 in the form of a reference table, and the actuation unit 1952 can apply actuating voltages to the diffractive optical modulator 1410 using the reference table. Accordingly, an actuating voltage for obtaining a desired light intensity is obtained by adding or subtracting a calibration voltage, calculated by the pixel-based calibration voltage calculation unit 1956, to or from an actuating voltage stored in the actuating voltage control unit 1956.

As described above, the present invention is advantageous in that it can accurately measure the displacement of the upper reflective parts of the diffractive optical modulator and can easily calibrate drive voltages accordingly.

Furthermore, according to the present invention, an optical path can be shortened using a condensing lens, therefore there is an advantage in that a small-sized device can be implemented.

Moreover, according to the present invention, a small-sized device can be implemented because an optical path can be shortened using a condensing lens, so that there is an advantage in that the small-sized device can be easily used in a small-sized terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for calibrating displacement of reflective parts of a diffractive optical modulator, comprising:
a sampling data output unit for providing calibration value calculation sampling data;
an optical modulator drive circuit for driving a diffractive optical modulator based on the calibration value calculation sample data from the sampling data output unit;
a light detection unit for measuring intensity of diffracted light emitted from the diffractive optical modulator, and outputting a measured light intensity value; and
a calibration value calculation unit for receiving the measured light intensity value from the light detection unit after the sampling data output unit outputs the calibration value calculation sampling data, constructing element-based calibration data based on the measured light intensity value, and outputting the constructed element-based calibration data.

2. The apparatus as set forth in claim 1, further comprising a memory for storing calibration value calculation sampling data.

3. The apparatus as set forth in claim 1, wherein:
the sampling data output unit provides pixel matching sample data to the optical modulator drive circuit; and
the calibration value calculation unit receives the measured light intensity value from the light detection unit, and then performs pixel matching based on the measured light intensity value after the sampling data output unit provides the pixel matching sample data.

4. The apparatus as set forth in claim 3, wherein the pixel matching sample data is configured such that a specific pixel value is assigned to at least one specific pixel and another identical pixel value is assigned to other pixels.

5. The apparatus as set forth in claim 4, wherein the calibration value calculation unit determines a corresponding detection position for the specific pixel using the measured light intensity value received from the light detection unit, and determines respective detection positions of the diffracted light, emitted from the diffractive optical modulator, for additional pixels.

6. The apparatus as set forth in claim 5, further comprising memory for storing the pixel matching sample data.

7. The apparatus as set forth in claim 1, wherein the light detection unit is a photodiode array capable of measuring the intensity of diffracted light emitted from the diffractive optical modulator.

8. The apparatus as set forth in claim 1, wherein:
the diffractive light modulator comprises a plurality of elements arranged to define individual pixels; and
the calibration value calculation sampling data is configured such that a pixel value increases or decreases at regular intervals.

9. The apparatus as set forth in claim 1, wherein:
the diffractive light modulator comprises a plurality of elements arranged to define individual pixels; and
the calibration value calculation sampling data is configured such that one or more active pixels and one or more pause pixels exist and a pixel value increases or decreases at regular intervals.

10. The apparatus as set forth in claim 1, wherein:
the diffractive light modulator comprises a plurality of elements arranged to define individual pixels; and
the calibration value calculation unit comprises:
a curve approximator for causing measured pixel-based light intensity values, measured by the light detection unit, to approximate a curve; and
a calibration value calculator for generating pixel-based calibration data based on the measured light intensity values caused to approximate a curve by the curve approximator.

11. The apparatus as set forth in claim 10, wherein:
the sampling data output unit continuously outputs calibration value calculation sampling data; and
the calibration value calculation unit further comprises a repetitive averager that averages continuously measured light intensity values received from the light detection unit.

12. The apparatus set forth in claim 10, further comprising a control unit for controlling the sampling data output unit to output the calibration value calculation sampling data.

13. The apparatus set forth in claim 12, wherein the control unit controls the sampling data output unit to continuously output calibration value calculation sampling data.

14. The apparatus set forth in claim 12, wherein the control unit controls the sampling data output unit to output pixel matching sampling data.

15. A method of calibrating displacement of reflective parts of a diffractive optical modulator, comprising the steps of:
(a) outputting calibration value calculation sampling data stored in memory;
(b) driving a diffractive optical modulator based on the outputted calibration value calculation sample data;
(c) measuring the intensity of diffracted light emitted from the diffractive optical modulator, and outputting a measured light intensity value; and
(d) constructing element-based calibration data based on the measured light intensity value, and outputting the constructed element-based calibration data.

16. The method as set forth in claim 15, further comprising the steps of:
(a) outputting pixel matching sample data stored in memory; and
(b) receiving the measured light intensity value from the light detection unit, and performing pixel matching.

17. The method of claim 16, wherein the pixel matching sample data stored in memory is configured such that a specific pixel value is assigned to at least one specific pixel and another identical pixel value is assigned to additional pixels.

18. The method as set forth in claim 17, wherein, in performing pixel matching, determining a corresponding detection position for a specific pixel using the measured light intensity value and determining corresponding detection positions of the diffracted light emitted from the diffractive optical modulator, for additional pixels.

19. The method as set forth in claim 15, wherein the calibration value calculation sampling data stored in memory is configured such that a pixel value increases or decreases at regular intervals.

20. The method of claim 15, wherein the calibration value calculation sampling data stored in memory is configured such that one or more active pixels and one or more pause pixels exist, and a pixel value increases or decreases at regular intervals.

21. The method of claim 15, wherein constructing element based calibration data based on the measured light intensity value comprises:
approximating pixel-based measured light intensity values to a curve; and
generating pixel-based calibration data based on the measured light intensity values caused to approximate a curve.

22. The method as set forth in claim 21, further comprising the steps of:
continuously outputting the calibration value calculation sampling data from memory; and
continuously averaging the measured light intensity values.

23. An apparatus for calibrating displacement of reflective parts in a diffractive optical modulator, the apparatus comprising:
a diffractive optical modulator for, when a test voltage is applied thereto, diffracting incident light according to the applied test voltage, and emitting a scan line in which a plurality of scanning diffracted light spots is arranged linearly;
separation means for separating the plurality of scanning diffracted light spots from the scan line in which the plurality of scanning diffracted light spots, emitted from the diffractive optical modulator, are arranged linearly;
a light detector for measuring and outputting a light intensity of the scan line incident through the separation means; and
a calibration unit for applying the test voltage to the diffractive optical modulator, calculating a calibration voltage by comparing the measured light intensity value, measured by the light detector, with an expected light intensity, expected to be measured by the light detector when the test voltage is applied to the diffractive optical modulator, and reflecting the calculated calibration voltage in a later actuating voltage.

24. The apparatus as set forth in claim 23, wherein the separation means comprises:
a reflecting mirror disposed on one side of the screen, and configured to reflect the scan line, emitted from the diffractive optical modulator, toward the light detector in a non-effective screen time section when the scan line, emitted from the diffractive optical modulator, is projected onto the screen; and
a condensing lens for separating the plurality of scanning diffracted light spots from the scan line in which the plurality of scanning diffracted light spots, reflected from the reflecting mirror, are arranged linearly.

25. The apparatus as set forth in claim 23, wherein the separation means comprises:
a translucent reflecting part for passing most of the scan line, emitted from the diffractive optical modulator, therethrough to the screen, and reflecting part of the scan line to the light detector; and
a condensing lens for separating the plurality of scanning diffracted light spots from the scan line in which the plurality of scanning diffracted light spots, reflected from the reflecting mirror, are arranged linearly.

26. The apparatus as set forth in claim 23, wherein:
the light detector measures and outputs a light intensity of diffracted light in a specific section in the linear diffracted light emitted from the diffractive optical modulator; and
the actuating voltage calibration unit compares the light intensity value, measured by the light detector, with light intensity, expected to be measured for the diffracted light in the specific section.

27. The apparatus as set forth in claim 23, wherein:
the light detector measures and outputs a light intensity for a scanning diffracted light spot, corresponding to each of pixels of an image formed on the screen, in a specific section in the linear diffracted light emitted from the diffractive optical modulator; and
the actuating voltage calibration unit compares the light intensity value, measured by the light detector, with light intensity, expected to be measured for the scanning diffracted light spot, corresponding to each pixel of the image formed on the screen.

28. The apparatus as set forth in claim 23, further comprising a filter for passing diffracted light having a specific diffraction order therethrough when the diffracted light emitted from the diffractive optical modulator is diffracted light having a plurality of diffraction orders.

29. The apparatus as set forth in claim 23, wherein the actuating voltage calibration unit comprises:
a test voltage storage unit for storing one or more test voltages;
an expected light intensity storage unit for storing one or more light intensities expected to be measured by the light detector for part of incident diffracted light when the test voltages are applied to the diffractive optical modulator;
an actuating voltage storage unit for storing actuating voltages that must be applied to the diffractive optical modulator so as to obtain diffracted light having specific light intensities;
an actuation unit for applying a test voltage, stored in the test voltage storage unit, to the diffractive optical modulator, and applying an actuating voltage, stored in the actuating voltage storage unit, to the diffractive optical modulator;
a pixel-based calibration voltage calculation unit for calculating a calibration voltage by comparing the measured light intensity value, measured by the light detector, with an expected light intensity, stored in the expected light intensity storage unit, and adding or subtracting the calculated calibration voltage to or from the test voltage stored in the test voltage storage unit, or adding or subtracting the calculated calibration voltage to or from the actuating voltage stored in the actuating voltage storage unit; and
a control unit for controlling the actuation unit and the pixel-based calibration voltage calculation unit.

30. The apparatus as set forth in claim 29, wherein each of the test voltages stored in the test voltage storage unit is an intermediate actuating voltage value between a maximum actuating voltage value and a minimum actuating voltage.

31. The apparatus as set forth in claim 30, wherein the test voltages stored in the test voltage storage unit are three or more test voltages.
